(19) United States
(12) Patent Application Publication
(10) Pub. No.: US 2014/0058973 A1
(43) Pub. Date: Feb. 27, 2014

(54) SYSTEM AND METHOD FOR GENERATING A STATEMENT OF WORK USING AN ELECTRONIC STATEMENT OF WORK TEMPLATE

(71) Applicant: Jon R. Bailey, Williamsport, IN (US)

(72) Inventor: Jon R. Bailey, Williamsport, IN (US)

(73) Assignee: CDW LLC, Vernon Hills, IL (US)

(21) Appl. No.: 13/595,325

(22) Filed: Aug. 27, 2012

(51) Int. Cl. G06Q 10/00

(52) U.S. Cl. 705/342

(57) ABSTRACT

A computing device may be implemented to generate a statement of work (SOW) between a first party and a second party. The first party may be an organization that provides goods or services to customers, and the second party may be one of a plurality of customers of the organization or one of a plurality of providers to the organization. The computing device may receive a selection of an electronic template and an indication of the second party, and may then retrieve both the selected electronic template and a portion of the stored SOW content standardized for the second party. The computing device may populate the first portion of the template with content, at least some of which is standardized to the second party, and it may populate the second portion of the template with content, at least some of which is not standardized for the second party.

### CROSS-REFERENCES TO RELATED APPLICATIONS

The present application is related to U.S. patent application Ser. No. ______ (Attorney Docket No. 31150/46703), entitled “SYSTEM AND METHOD FOR POPULATING CONTENT WITHIN AN ELECTRONIC STATEMENT OF WORK TEMPLATE,” filed on the same day as the present application, the entire disclosure of which is hereby incorporated by reference herein for all purposes. The present application is also related to U.S. patent application Ser. No. ______ (Attorney Docket No. 31150/46704), entitled “SYSTEM AND METHOD FOR POPULATING AN ELECTRONIC STATEMENT OF WORK TEMPLATE BASED ON CORRESPONDING CONTENT OF ANOTHER ELECTRONIC STATEMENT OF WORK TEMPLATE,” filed on the same day as the present application, the entire disclosure of which is hereby incorporated by reference herein for all purposes.

### TECHNICAL FIELD

This disclosure relates generally to Statements of Work (SOWs) and, more particularly, to efficiently creating and managing SOWs.

### BACKGROUND

A Statement of Work (SOW) may define particular work that an organization (e.g., contractor) will perform for a customer. The SOW may specify additional agreements made between the organization and the customer, such as an agreement regarding a period of time during which the work is to be performed. In some cases, a SOW may define particular work that a provider (e.g., subcontractor) will perform for an organization (e.g., contractor), for the ultimate benefit of the organization's customer.

In many cases, an employee of the organization will create a SOW by accessing a database or other repository of SOW terms and conditions, identifying the terms and conditions that should be included in the SOW being created, and inserting the identified terms and conditions into the SOW being created. The database or repository may include SOW terms and conditions for numerous customers and/or providers. In some cases, the employee may also type portions of the SOW content “from scratch” when the SOW content that is needed is not stored in the database or repository.

### SUMMARY

Methods are described for generating a statement of work (SOW) between a first party and a second party. In some embodiments, the method includes receiving, with one or more computing devices, a selection of an electronic template that is to be used to generate the SOW between the first party and the second party. The computing devices may include a processor executing at least a portion of a SOW application and a memory coupled to the processor to store data associated with the execution of the SOW application. The first party may be an organization that provides at least one of goods or services to customers, and the second party may be one of a plurality of customers of the organization or one of a plurality of providers to the organization. The method also may include receiving an indication of the second party to the SOW and retrieving the selected electronic template from one or more databases that store a plurality of electronic templates including the selected electronic template, and that store SOW content associated with a plurality of SOW categories. The method also may include retrieving a portion of the stored SOW content that is standardized for the second party. The method may also include receiving one or more indications from a user of additional content that is to be included in the SOW between the organization and the second party that is not standardized for the second party, and populating a first portion of the selected electronic template with content including at least some of the portion of the stored SOW content that is standardized for the second party, and populating a second portion of the selected electronic template that is distinct from the first portion with the additional content that is to be included in the SOW and that is not standardized for the second party.

In some embodiments, a centralized system of work (SOW) system for generating a SOW between a first party and a second party may comprise one or more databases storing a plurality of electronic templates and SOW content associated with a plurality of SOW categories. The system may also comprise one or more computing devices each having a processor and a memory coupled to the processor, the one or more computing devices communicatively coupled to the one or more databases. The one or more computing devices may be configured to receive a selection of an electronic template used to generate the SOW between the first and second party, wherein the first party to the SOW is an organization that provides at least one of goods or services to customers, and wherein the second party to the SOW is one of a plurality of customers of the organization or one of a plurality of providers to the organization. The one or more computing devices may be further configured to receive an indication of an identity of the second party to the SOW, retrieve the selected electronic template from the one or more databases, and retrieve from the one or more databases, based on the indication of the identity of the second party, a portion of the stored SOW content that is standardized for the second party. The one or more computing devices may be further configured to receive one or more indications from a user of additional content that is to be included in the SOW between the organization and the second party and that is not standardized for the second party. The one or more computing devices may also be configured to populate a first portion of the selected electronic template with content including at least some of the portion of the stored SOW content that is standardized for the second party, and to populate a second portion of the selected electronic template that is distinct from the first portion of the selected electronic template with the additional content that is to be included in the SOW and that is not standardized for the second party. The one or more computing devices may be further configured to generate the SOW between the organization and the second party based on the selected electronic template such that the generated SOW includes the content populated within the first and second portions of the selected electronic template.

In some embodiments, a method for use in generating a statement of work (SOW) between a first party and a second party, the first party being an organization that provides at least one of goods or services to customers, may comprise receiving, with one or more computing devices, each having a processor executing at least a portion of a SOW application and a memory coupled to the processor to store data associated with execution of the SOW application, an indication of an electronic template corresponding to the SOW between the organization and the second party, wherein the second party is one of a plurality of customers of the organization or one of a plurality of providers to the organization. The method may also comprise receiving, with one or more computing devices, a plurality of indications from a user of content to be included in the SOW between the organization and the second party. The method may additionally comprise dividing, with the one or more computing devices, a first portion of the indicated content that is standardized for the second party from a second portion of the indicated content that is not standardized for the second party so that the first portion of the indicated content is included within a first portion of the indicated electronic template and the second portion of the indicated content is included within a second portion of the indicated electronic template that is distinct from the first portion of the indicated electronic template, without receiving an indication from the user of which portion of the indicated content is the first portion that is standardized for the second party. The method may further comprise generating, with one or more of the computing devices, the SOW between the organization and the second party based on including the first portion of the indicated content within the first portion of the indicated electronic template and including the second portion of the indicated content within the second portion of the indicated electronic template.

Other systems, methods, features and advantages of the invention will be, or will become, apparent to those skilled in the art upon examination of the following figures and detailed description. It is intended that all such additional systems, methods, features and advantages included within this description be within the scope of the invention.

### BRIEF DESCRIPTION OF THE DRAWINGS

FIG. 1 is a block diagram of an example system for creating and managing Statements of Work (SOWs), according to various embodiments;

FIG. 2 is a flow chart of an example method for creating and managing SOWs, according to various embodiments;

FIG. 3 is a screenshot of an example SOW application home page, according to various embodiments;

FIG. 4 is a diagram of the layout of an example SOW template, according to various embodiments;

FIG. 5 is a flow chart of an example method for flowing content into a SOW template, according to various embodiments;

FIG. 6A is a flow chart of an example method for “flipping” a provider-facing SOW template in order to generate a corresponding customer-facing SOW template, according to various embodiments; and

FIG. 6B is a flow chart of an example method for “flipping” a customer-facing SOW template in order to generate a corresponding provider-facing SOW template, according to various embodiments.

### DETAILED DESCRIPTION

The following text sets forth a detailed description of numerous different embodiments. However, it should be understood that the detailed description is to be construed as exemplary only and does not describe every possible embodiment since describing every possible embodiment would be impractical. One of ordinary skill in the art will recognize, in light of the teaching and disclosure herein, that numerous alternative embodiments could be implemented.

It should be understood that, unless a term is expressly defined in this patent application using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application.

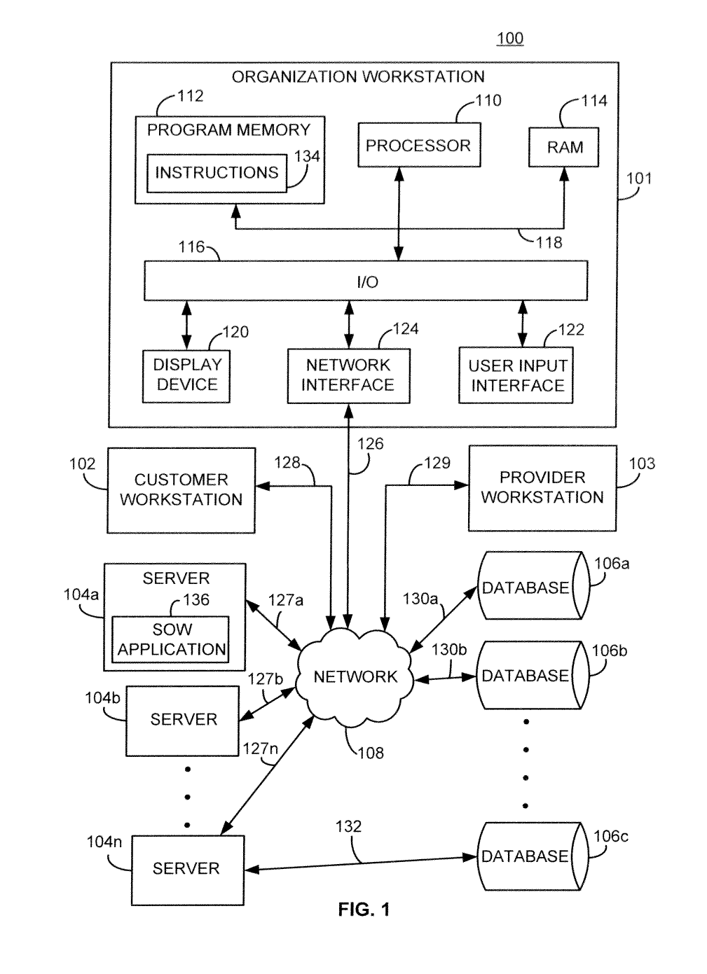

FIG. 1 is a block diagram of an example system 100 for use in generating Statements of Work (SOWs), according to various embodiments of the present invention. The example system 100 includes an organization workstation 101, a customer workstation 102, a provider workstation 103, a plurality of servers 104a-104n, a plurality of databases 106a-106n, and a network 108. The organization workstation 101 may be owned by, operated by, or otherwise accessible to an organization that provides goods and/or services to customers. As just a few examples, the organization may provide computer hardware and software products to customers, and/or the organization may provide information technology consulting services to customers.

As further discussed below, the organization may engage a provider (or more than one provider) with respect to a particular SOW that defines goods and/or services that the organization is to provide to a particular customer. A provider to the organization may also be referred to as, for example, a vendor to the organization, particularly where the organization engages the provider to provide goods to the customer, or where the organization engages the provider to provide goods to the organization for eventual provision of the goods to the customer. Additionally or alternatively, a provider to the organization may be referred to as a subcontractor, particularly where the organization essentially functions as a general contractor with respect to the customer. Accordingly, it will be understood that the terms “provider,” “vendor,” “subcontractor” and the like, as used herein, are interchangeable.

The organization workstation 101 may serve as a user interface for generating a SOW or SOWs, such as a SOW between the organization and a customer and/or a SOW between the organization and a provider to the organization that is engaged by the organization with respect to a particular SOW between the organization and a customer. In some embodiments, the system 100 may include multiple organization workstations 101 via which one or more users (e.g., employees of the organization's sales division) may contribute content to a single SOW or to multiple SOWs at a particular time. In some embodiments, the organization workstation(s) 101 may be any suitable electronic device or devices, including but not limited to a laptop computer, desktop computer, personal digital assistant, cellular telephone, other wireless device, etc.

For the sake of simplicity, a simplified block diagram of the organization workstation 101 is shown in FIG. 1. The organization workstation 101 may include a processor 110 (which may also be referred to as a microcontroller or a microprocessor) for executing computer executable instructions, a program memory 112 for permanently storing data related to the computer executable instructions, a random-access memory (RAM) 114 for temporarily storing data related to the computer executable instructions, such as data associated with execution of the computer executable instructions, and an input/output (I/O) circuit 116, all of which may be interconnected via an address/data bus 118.

It should be appreciated that although only one processor 110 is shown, the organization workstation 101 may include multiple processors 110. Additionally or alternatively, the processor(s) 110 may be a multi-core processor(s). Similarly, the memory of the organization workstation 101 may include multiple RAMs 114 and/or multiple program memories 112. The RAM(s) 114 and program memory(ies) 112 may be implemented as semiconductor memories, magnetically readable memories, optically readable memories, and/or other tangible, non-transitory computer-readable media, for example. Additionally, although the I/O circuit 116 is shown as a single block, it should be appreciated that the I/O circuit 116 may include a number of different types of I/O circuits. For example, a first I/O circuit may correspond to a display device 120 of the organization workstation 101, and the first or a second I/O circuit may correspond to a user input/output interface 122 of the organization workstation 101. The user input/output interface 122 may be or may include, for example, a keyboard, a mouse, a touch screen, a voice activation device, or any other known or later-developed user input/output interface device. In some embodiments, the display device 120 and the user input/output interface 122 may be jointly incorporated in a single physical device. The organization workstation 101 may also include other elements common to general purpose computing devices.

The organization workstation 101 may be operatively connected to the network 108 via a network interface 124 and a link 126. The network 108 may be or may include a private network, a public network, or some combination of the two. At least a portion of the network 108 may be privately administered by the organization and may be firewalled from public networks. The network 108 may be or may include a client-server network, a peer-to-peer network, an Ethernet network, a cloud computing network, or any other known type of network in which computing devices are enabled to communicate. In some embodiments, the network 108 may include more than one network and/or portions of more than one network, including more than one different type of network.

The link 126 may be as simple as a memory access function or an Ethernet connection, and/or the link 126 may be a wired, wireless, or multi-stage connection. Many types of links are known in the art of networking and may be used in conjunction with the organization workstation 101. In some embodiments, while not shown as such in FIG. 1, at least one of the display device 120 or the user input/output interface 122 may be remotely connected to the organization workstation 101 using the network 108 and the link 126.

The organization workstation 101 may be in communicative connection with the servers 104a-104n via the link 126, the network 108, and links 127a-127n. Thus, the servers 104a-104n may be located remotely from the organization workstation 101. It is noted that while a plurality of servers 104a-104n are shown in FIG. 1, the system 100 may alternatively include only a single server 104. Further, if desired, the operation of such a single server 104 may be incorporated within the organization workstation 101 and the single server 104 may be removed. The customer workstation 102 may be owned by, operated by, or otherwise accessible to a customer of the organization. It is noted that while only one customer workstation 102 is shown in FIG. 1 for the sake of simplicity, the system 100 may include multiple customer workstations 102, such as one or more customer workstations 102 for each of the organization's customers. The provider workstation 103 may be owned by, operated by, or otherwise accessible to a provider engaged by the organization to provide goods and/or services with respect to SOWs between the organization and its customers. It is noted that while only one provider workstation 103 is shown in FIG. 1 for the sake of simplicity, the system 100 may include multiple provider workstations 103, such as one or more provider workstations 103 for each provider that is engaged (or that is to be engaged) by the organization. The customer workstation 102 may be in communicative connection with the servers 104a-104n via a link 128, the network 108, and the links 127a-127n. The provider workstation 103 may be in communicative connection with the servers 104a-104n via a link 129, the network 108, and the links 127a-127n. While not illustrated as such, the customer workstation(s) 102 and the provider workstation(s) 103 may each include elements typically found in general purpose computing devices and similar to the organization workstation 101, such as a program memory, a processor, a RAM, a bus, a display, a user input/output interface, a network interface, and other elements.

Further, although not illustrated as such, the servers 104a-104n may each also include elements typically found in general purpose computing devices and similar to the organization workstation 101, such as a program memory, a processor, a RAM, a bus, a display, a user input/output interface, a network interface, and other elements. The servers 104a-104n may be communicatively coupled to the databases 106a-106n via corresponding links. In some cases, one or more of the servers 104a-104n may be communicatively coupled to one or more of the databases 106a-106n via one or more of the links 127a-127n, the network 108, and one or more links 130. For example, FIG. 1 shows the servers 104a and 104b communicatively coupled to the databases 106a and 106b via the links 127a and 127b, the network 108, and links 130a and 130b, where the links 130a and 130b are links between the network 108 and the databases 106a and 106b, respectively. In some cases, one or more of the servers 104a-104n may be communicatively coupled to one or more of the databases 106a-106n via one or more links 132 that effectively bypass the network 108 for purposes of communication between the one or more of the servers 104a-104n and the one or more of the databases 106a-106n. For example, FIG. 1 shows the server 104n communicatively coupled to the database 106n via a link 132 and not via the network 108. In any event, similar to the link 126, each of the links 127a-127n, the links 130, and the links 132 may be any suitable type of link.

It is noted that while FIG. 1 shows each of the servers 104a-104n coupled to a respective one of the databases 106a-106n, such an implementation is not required, and one or more of the servers 104a-104n may instead be coupled to multiple ones of the databases 106a-106n (including ones of the databases 106a-106n that are also coupled to other ones of the servers 104a-104n), a non-respective one of the databases 106a-106n, none of the databases 106a-106n, etc. For example, one or more of the servers 104a-104n may be directly coupled to another one or more of the servers 104a-104n, such as in a case where the one or more of the servers 104a-104n offloads data to the other one or more of the servers 104a-104n for more intensive processing that may be more efficiently performed by the other one or more of the servers 104a-104n. In some embodiments, one or more of the databases 106a-106n may be contained within the organization workstation 101, and/or one or more of the databases 106a-106n may be contained within one or more of the servers 104a-104n.

The databases 106a-106n may be or may include any suitable databases or data storage entities. In some embodiments, the system 100 may include only a single database 106. The databases 106a-106n may store content for generating SOWs, as further described below.

The organization workstation 101 may include one or more sets of computer-executable instructions 134 for accessing a SOW application 136 that may in turn be used to generate SOWs as further described below. As used herein, the terms “computer-executable instructions,” “computer executable instructions,” “instructions” and the like are interchangeable. The instructions 134 may be stored in the program memory 112 and executable by the processor 110. The SOW application 136 may be hosted by (e.g., stored in memory of) one or more of the servers 104a-104n, such as by the server 104a as shown in the example of FIG. 1. The SOW application 136 may be implemented using computer-executable instructions that constitute one or more computer programs or portion(s) or routine(s) thereof. The SOW application 136 may be, for example, a web-based application, and the computer-executable instructions 134 may allow the organization workstation 101 to present an interactive web page to a user so that the user is able to generate one or more SOWs using the SOW application 136. For example, the computer-executable instructions 134 may be, or may be part of, a web browser program.

In some embodiments, the SOW application 136 may be executed by more than one of the servers 104a-104n. That is, different ones of the servers 104a-104n may execute different portions of the computer-executable instructions constituting the SOW application 136. For example, the server 104a and a server 104b may each execute a portion of the computer-executable instructions constituting the SOW application 136. As another example, the server 104a and the server 104n may each execute a portion of the computer-executable instructions constituting the SOW application 136, and one or both of the server 104a and the server 104n may communicate with the organization workstation 101 so that the organization workstation 101, using the computer-executable instructions 134, may present an interactive web page to a user of the organization workstation 101, as described above.

In other examples, the SOW application 136 may be usable offline, i.e., while the organization workstation 101 is not communicatively connected to the network 108. SOWs that are created and/or modified offline using the SOW application 136 may then be uploaded to one or more of the servers 104a-104n when the organization workstation 101 is later communicatively connected to the network 108. Similarly, each of the customer workstation 102 and the provider workstation 103 may be used offline to review content populated within an electronic SOW template by the SOW application 136, and a user thereof may later sign on to a customized web-based portal to upload any requested changes or an indication of approval. Customized web-based portals for customers and providers are further discussed below.

In still other examples, the SOW application 136 may be stored in memory of, for example, the organization workstation 101, and the plurality of servers 104a-104n may not be included in the system 100 or may not be used to implement the SOW application 136. In such examples, the computer-executable instructions 134 may include computer-executable instructions constituting the SOW application 136.

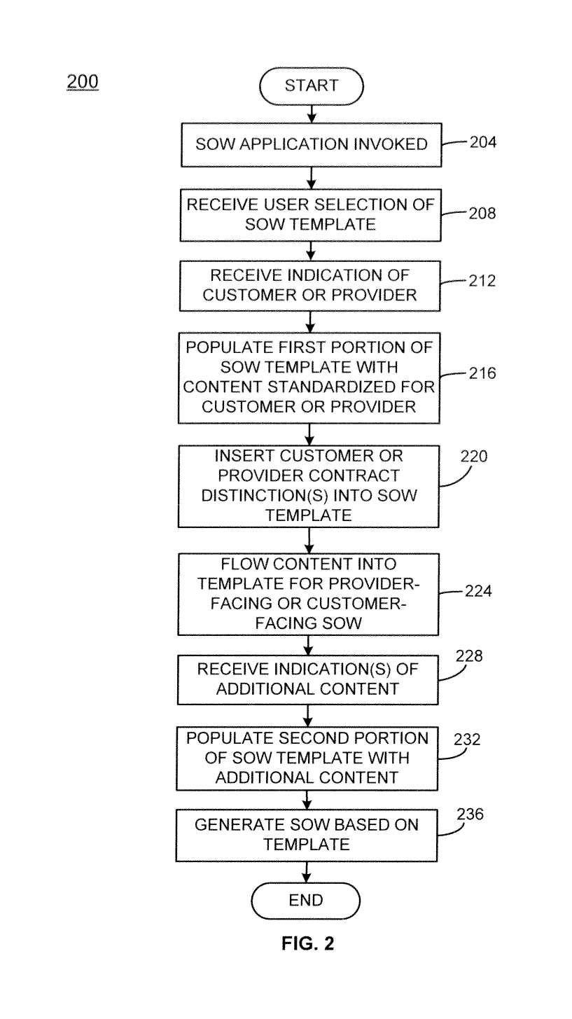

FIG. 2 is a flow chart of an example method 200 for generating SOWs, according to various embodiments of the present invention. For ease of explanation, the method 200 will be described with reference to the system 100 of FIG. 1. However, it will be understood that the method 200 may be implemented using a system other than the system 100. It will be further understood that in at least some embodiments, FIG. 2 represents one or more portions or routines of one or more computer programs used in implementing the SOW application 136. The majority of the software utilized to implement the one or more portions or routines may be stored in portions of one or more suitable memories within or coupled to the servers 104a-104n (e.g., a memory within one of the servers 104a-104n that is similar to the program memory 112). The software may be written at any high-level language such as C, C++, C#, Java or the like, or any low-level assembly or machine language. By storing the computer program portion(s) or routine(s) or computer-executable instructions therein, those portions of the server memory (or memories) are physically and/or structurally configured in accordance with the stored program portion(s) or routine(s) or instructions. Parts of the software, however, may be stored and run in one or more other memory locations if desired.

The method 200 may begin when the SOW application 136 is invoked (block 204). The SOW application 136 may be invoked by a user of the organization workstation 101, such as by delivering one or more suitable input commands to the organization workstation 101 via the user input/output interface 122. The input command(s) may be transmitted to one or more of the servers 104a-104n via the network interface 124, the link 126, the network 108, and one or more of the links 127a-127n.

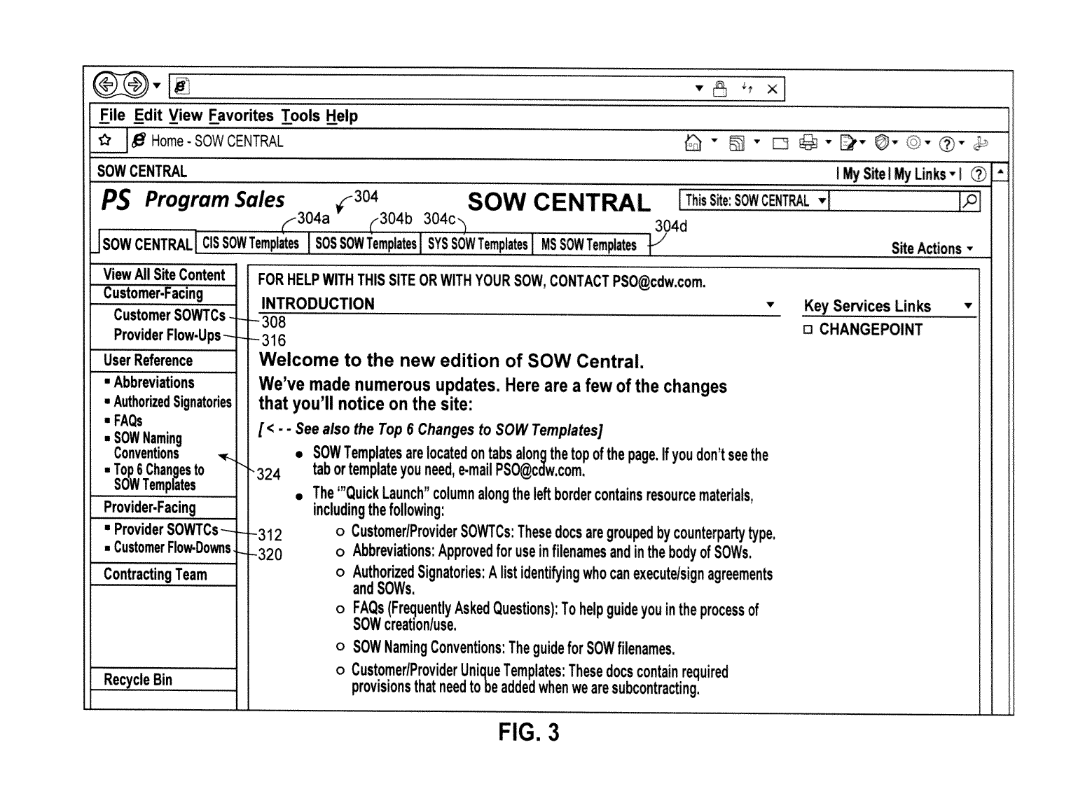

When the SOW application 136 is invoked (block 204), one or more of the servers 104a-104n may transmit a main or “home” page of the SOW application 136 to the organization workstation 101. For example, the SOW application 136 may be provided as or accessible via a web-based portal, and one or more of the servers 104a-104n may be a web server that serves the home page of the SOW application 136 to the organization workstation 101 when the SOW application 136 is invoked. FIG. 3 is a screenshot of an example SOW application home page 300. The SOW application home page 300 may include SOW template options 304, a customer SOW terms and conditions (Ts & Cs) option 308, a provider (e.g., subcontractor) SOW Ts & Cs option 312, a provider flow-ups option 316, a customer flow-downs option 320, and user reference options 324. These options are described in greater detail below.

The SOW template options 304 may be or may include options corresponding to a number of different categories of electronic SOW templates that may be used to generate SOWs as described below. In the example of FIG. 3, the SOW application home page 300 includes a SOW template option 304a corresponding to converged infrastructure solutions (CIS), a SOW template option 304b corresponding to software solutions (SoS), a SOW template option 304c corresponding to system solutions (SyS), and a SOW template option 304d corresponding to managed services (MS). A user of the SOW application 136 (e.g., a user of the organization workstation 101) may select one of the SOW template options 304 using the user input/output interface 122. In another example, the user of the SOW application 136 may be a user located remotely from the organization workstation 101, such as a user of another workstation (not shown) communicatively coupled to the servers 104a-104n, a user of one of the servers 104a-104n, etc.

In any event, upon selection of one of the SOW template options 304, the SOW application 136 may cause one or more lists of SOW templates to be presented to the user via the display device 120. For example, each individual within the organization who uses or who may use the SOW application 136 may belong (e.g., be assigned) to one or more user groups. Each user group may, for example, have access to one or more categories of SOW templates provided by the SOW application 136. More particularly, the SOW application 136 may allow access to a particular SOW template by only those users who belong to the group(s) having access to the category that includes the particular SOW template. In some embodiments, each of the SOW template options 304 may correspond to a category of SOW templates, and the SOW application 136 may display only the SOW template option(s) 304 corresponding to the category(ies) of SOW templates that is (are) accessible by the group(s) to which a current user of the SOW application 136 belongs. In any event, the SOW application 136 may provide the appropriate level(s) of access to a particular user based on login/authentication information (e.g., a username and password) of the particular user.

As a more detailed example, a first user may be responsible for creating SOWs pertaining to advanced information technology (IT) support services, and may belong to a corresponding first user group, which in turn may have access to a first category of SOW templates associated with advanced IT support services. A second user may be responsible for creating SOWs related to equipment installation services, and may also be responsible for creating SOWs related to assessment, planning, and design services. The second user may belong to corresponding second and third user groups, which in turn may have access to corresponding second and third categories of SOW templates associated with equipment installation services and assessment, planning, and design services, respectively. In this example, the SOW application 136 will allow the first user access to only the SOW templates associated with advanced IT support services, and will allow the second user access to only the SOW templates associated with equipment installation services and assessment, planning, and design services.

In any event, the user may use the organization workstation 101 to select an electronic SOW template to which the user has access, and the SOW application 136 may receive the user's selection (block 208). In some embodiments, the SOW application 136 may utilize primary templates and sub-templates, where sub-templates may include, for example, additional fields corresponding to a particular type or category of goods or services to be provided under the SOW. For example, the SOW application 136 may cause the organization workstation 101 to first display one or more lists of primary templates, and after the user selects a primary template, the SOW application 136 may cause the organization workstation 101 to display a list of possible sub-templates for use with the selected primary template. The function described by the block 208 may then receive the user's selection of one of the possible sub-templates. For the sake of brevity, a primary template and sub-template may be collectively referred to herein as a “SOW template,” it being understood, however, that a “SOW template” need not always correspond to a primary template and a sub-template.

In situations where the method 200 is used to create (generate) a new SOW, the SOW application 136 may receive an indication of a customer or provider (e.g., subcontractor) that is to be a party to the SOW (block 212). Generally speaking, the method 200 may be used to create and/or manage SOWs between an organization and a customer, and/or to create and/or manage SOWs between an organization and a provider. Thus, while the following description at times refers primarily to SOWs between an organization and a customer, it will be understood that the described features may also be implemented, as appropriate, in the context of SOWs between an organization and a provider. Similarly, while the following description at times refers primarily to the creation of new SOWs, it will be understood that the described features may also be implemented, as appropriate, in the context of managing (e.g., editing) existing SOWs.

The function described by the block 212 may cause the organization workstation 101 to display one or more customer search fields to the user or may allow a user to select from a dropdown-generated list of customers. Each search field may prompt the user for certain information pertaining to the customer that is to be a party to the SOW, such as a name, address, account number, customer category, etc. The user may use the search field(s) to enter as much or as little information about the customer as is desired or known to the user, and the organization workstation 101 may transmit the entered information to the SOW application 136, thus indicating the identity of the customer to the SOW application 136. In particular, the SOW application 136 may compare the received customer information to customer information stored in one or more of the databases 106a-106n. The SOW application 136 may identify one or more customers whose stored customer information matches the customer information entered by the user, and the SOW application 136 may cause an indication of the matching customer(s) to be transmitted back to the organization workstation 101 for display to the user. Alternatively, if the SOW application 136 does not identify any matching customer information in the databases 106a-106n, the SOW application 136 may cause a suitable re-try prompt to be transmitted to the organization workstation 101 for display to the user. The user may then attempt to enter different or corrected customer information that will yield a match.

The user may verify the identity of the customer that is to be a party to the SOW by confirming an indication of a single match, choosing one customer from a list of multiple matches, or entering further information to narrow a list of multiple matches down to a single match. Once the user has verified the identity of the customer, the SOW application 136 may populate the selected electronic SOW template with information (also referred to interchangeably herein as “content”) that is standardized for the customer (block 216). For example, the function described by the block 216 may populate the selected SOW template with information that the organization and the customer have previously negotiated and have agreed is to be included, as a general matter, in every SOW between the organization and the customer. In some embodiments, information standardized for the customer may have been agreed upon as part of a master agreement between the organization and the customer that applies to all services for the customer that are rendered by or on behalf of the organization. In some cases, when the SOW application 136 identifies a single matching customer, the function described by the block 216 may populate the information standardized for the customer without any option for the user to verify the identity of the customer.

The information standardized for the customer (or provider) may be stored in the databases 106a-106n. For example, the databases 106a-106n may store, for each of a number of customers and providers, indications of customer-specific (or provider-specific) terms and conditions and/or indications of customer-specific (or provider-specific) project-specific terms and conditions. A user of the organization workstation 101 may view the stored terms and conditions for various customers by selecting the customer SOW Ts & Cs option 308 as shown in FIG. 3, in some embodiments Likewise, in some embodiments, a user of the organization workstation 101 may view the stored terms and conditions for various providers by selecting the provider SOW Ts & Cs option 312. Of course, the foregoing are merely examples of information that could be standardized, and it will be appreciated from the disclosure herein that any suitable customer-specific (and/or provider-specific) information may be standardized and used accordingly by the SOW application 136 in order to more efficiently create, edit, and distribute SOWs.

Customer-specific terms and conditions may include, for example, language specifying what content in a SOW qualifies as a statement of a deliverable, statements of industry standards that are to be met in the provision of goods and/or services under the SOW, regulatory and governance terms and conditions, references to the master agreement, miscellaneous terms and conditions, and/or any other suitable terms and conditions that the organization and a particular customer may agree (e.g., in a master agreement) are to be included, as a general matter, in every SOW between the organization and the particular customer. It is noted that, for example, language specifying what content in a SOW qualifies as a statement of a deliverable may be useful to the organization in protecting against risky provisions in the SOW.

In some embodiments, customer-specific terms and conditions may also or alternatively include, for example, information that purposefully contradicts or expands upon one or more of the terms and conditions set forth in the master agreement between the organization and the particular customer. In such embodiments, the customer-specific terms and conditions may utilize (e.g., refer to) defined terms in the master agreement in order to clarify how terms and conditions of the master agreement are affected by (e.g., contradicted by) the customer-specific terms and conditions.

In some embodiments, one or more sets of default terms and conditions may be defined and stored in the databases 106a-106n. According to various embodiments, default terms and conditions are terms and conditions that are to be included, as a general matter, in any SOW between the organization and any customer (or provider), in any SOW between the organization and any of a broad class of customers (or providers), etc. In other words, default terms and conditions may be standardized at a more general level than that of an individual customer (or provider). Default terms and conditions may be populated within the selected SOW template at any suitable time, including when customer-specific terms and conditions and other standardized information are populated (block 216).

Customer-specific project-specific terms and conditions may include terms and conditions that the organization and the customer have agreed (e.g., in a master agreement) are to be included, as a general matter, in every SOW between them that pertains to a particular type of project. For example, a particular customer may have a first set of project-specific terms and conditions that are to be included in every SOW between the organization and the customer that pertains to IT staff training. The same customer may also have a second set of project-specific terms and conditions that are to be included in every SOW between the organization and the customer that pertains to, for example, installation of new computing devices. In some embodiments, the SOW application 136 may populate the user-selected SOW template with the appropriate set of project-specific terms and conditions based on the category to which the user-selected SOW template belongs.

In the aforementioned example, if the user-selected SOW template belongs to a first category of SOW templates associated with advanced IT support services, then the function described by the block 216 may populate the user-selected SOW template with the customer's first set of project-specific terms and conditions pertaining to IT staff training. On the other hand, if the user-selected SOW template belongs to, for example, a second category of SOW templates associated with equipment installation services, then the function described by the block 216 may populate the user-selected SOW template with the customer's second set of project-specific terms and conditions pertaining to computing device installation. In other words, the function described by the block 216 may populate the user-selected SOW template with the set of project-specific terms and conditions that most closely match the properties of the selected SOW template. The function described by the block 216 may make the determination of which set of project-specific terms and conditions most closely matches the properties of the selected SOW template in any suitable manner, such as, for example, by using one or more look-up tables.

In some embodiments, the function described by the block 216 may cause an option to de-select the determined set of project-specific terms and conditions to be transmitted to the organization workstation 101 for display to the user. Thus, the user may be able to override the determination of a particular set of project-specific terms and conditions to use in populating the user-selected SOW template. Still further, in some embodiments, the function described by the block 216 may identify the set of project-specific terms and conditions that most closely matches the properties of the selected SOW template, and instead of populating the selected SOW template with the identified set of project-specific terms and conditions, the function described by the block 216 may first prompt the user to choose whether or not to populate the selected SOW template with the identified set of project-specific terms and conditions.

In still other embodiments, when the indicated customer has more than one set of project-specific terms and conditions, the SOW application 136 may cause a suitable indication (e.g., a list, a summary, etc.) of the sets of project-specific terms and conditions to be presented to the user of the organization workstation 101. The user may then select one or more of the sets of project-specific terms and conditions for use in the SOW being created, and the SOW application 136 may insert the selected set(s) into the SOW template accordingly.

Still further, in some embodiments, one or more of the organization's customers may each have one or more sets of optional project-specific terms and conditions. Optional project-specific terms and conditions may, for example, not be associated with particular types of goods or services, but may be available for population within the selected SOW template at the discretion of the user of the organization workstation 101. Such optional project-specific terms and conditions may also be displayed in, for example, the form of a list or summary, for selection by the user and subsequent population within the selected SOW template. The SOW application 136 may also allow a user of the organization workstation 101 to write additional project-specific terms and conditions that are to be populated within the selected SOW template. The user may, for example, select a suitable option displayed on the display device 120 via the user input/output interface 122 in order to type additional project-specific terms and conditions into a text box that may be displayed on the display device 120 in response to the user's selection. The function described by the block 216 may thereafter receive the text typed into the text box and cause the typed text to be populated within the selected SOW template.

It is further noted that in some cases, a customer may only have one set of project-specific terms and conditions. Consequently, the SOW application 136 may simply populate the selected SOW template with the one set of project-specific terms and conditions. In some embodiments, the SOW application 136 may cause an option to be provided to the user that allows the user to de-select the one set of project-specific terms and conditions if the user does not wish the one set of project-specific terms and conditions to appear in the SOW being created. In still other embodiments, the SOW application 136 may not pre-select the one set of project-specific terms and conditions for population in the selected SOW template, and may instead cause an option to be provided to the user that allows the user to make the initial determination as to whether the one set of project-specific terms and conditions is to be included in the SOW being created.

Furthermore, in some embodiments, a set of project-specific terms and conditions may be defined not on a per-customer basis, but on a per-group basis. For example, the organization may enter into one or more purchasing contracts with one or more groups of customers. A customer who is a member of such a group may purchase goods and/or services from the organization pursuant to terms and conditions specified within the group contract, as opposed to purchasing goods and/or services pursuant to terms and conditions within the customer's master agreement with the organization. When a customer who is a member of such a group elects to purchase goods and/or services pursuant to the terms and conditions specified within the group contract, a set of project-specific terms and conditions corresponding to (e.g., specified within) the group contract may be inserted into the selected SOW template. For example, the group contract may have only a single set of project-specific terms and conditions that is populated each time a customer from the group is a party to a SOW to be created. In other examples, multiple sets of project-specific terms and conditions may be associated with a group contract, and one or more of the multiple sets may be populated within the selected SOW template in any desired manner, such as in a manner similar to the various techniques described above with respect to project-specific terms and conditions that are defined on a per-customer basis.

Still further, in some embodiments, one or more sets of default project-specific terms and conditions may be defined and stored in the databases 106a-106n. In some embodiments, default project-specific terms and conditions are terms and conditions that are to be included, as a general matter, in any SOW between the organization and any of a broad class of customers (or providers) that pertains to a certain type(s) of project(s). In other words, default project-specific terms and conditions may be standardized at a more general level than that of an individual customer (or provider). Default project-specific terms and conditions may be populated within the selected SOW template at any suitable time, including when customer-specific project-specific terms and conditions and other standardized information are populated (block 216).

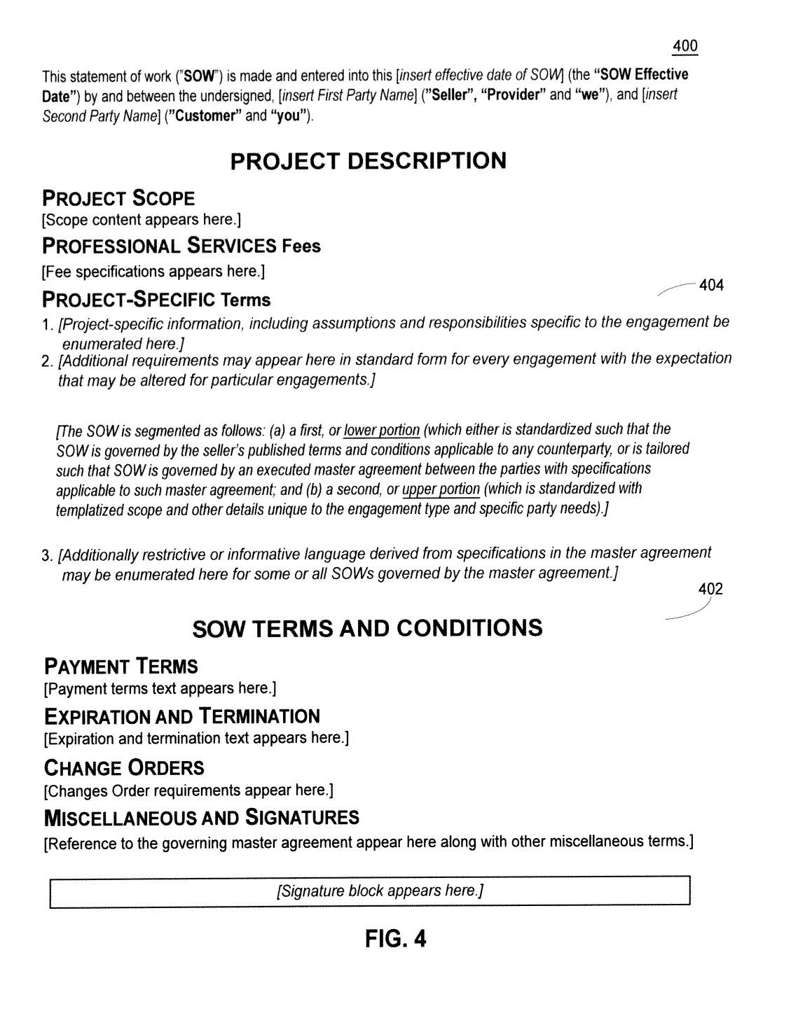

With regard to customer-specific terms and conditions, customer-specific project-specific terms and conditions, and/or other types of information standardized for a customer (or provider), the function described by the block 216 may, more specifically, populate a first portion of the selected SOW template with the standardized information. FIG. 4 is a diagram of the layout of an example SOW template 400 including a first, or lower, portion 402 and a second, or upper, portion 404. This basic layout of the example SOW template 400 may be implemented in conjunction with each SOW template provided by the SOW application 136, and thus various SOW templates provided by the SOW application 136 may at times be described herein using the same reference numerals as the SOW template 400 for ease of explanation. In the example of FIG. 4, the first portion 402 is a lower portion of the SOW template 400 and is distinct from the second portion 404, which is an upper portion of the SOW template 400. According to various embodiments, the first portion 402 may be customized for the customer (or provider) that is to be a party to the SOW, and thus may be the portion of the SOW template 400 that is populated with the information standardized for the customer (or provider) (block 216). The second portion 404 may be used to contain additional information that is not standardized for the customer, as further described below.

By providing SOW templates having a basic structure in accordance with the example SOW template 400, the SOW application 136 allows more efficient review and approval of SOWs by contracting parties. For example, when the first portion 402 is populated with standardized information from a master agreement that the organization and the customer have previously entered into, the customer can limit most or all of its review of its SOWs to other information (e.g., information that is not standardized for the customer) present in the second portion 404. Moreover, by providing a template structure that includes standardized information in a particular portion, the SOW application 136 will in many cases make it easier for the organization to assure a customer (or provider) that such standardized information will regularly appear in SOWs to which the customer (or provider) is a party. The structure of the SOW template 400 also makes it easier for a customer (or provider) to verify that such standardized information appears in its SOWs with such regularity. As a result, it is generally expected that customers and providers will be increasingly willing to use SOW templates that are developed by the organization as opposed to insisting on the use of their own customized templates, thus saving time and expense in creating and modifying SOWs and significantly increasing the extent to which SOW creation and modification can be automated.

Further, because the SOW template 400 provides greater assurance that standardized language, including language protecting against risk (as discussed above), will regularly appear in SOWs to which a particular customer (or provider) is a party, it is expected that the SOW application 136 will greatly increase the ease with which an organization can develop master agreements with its customers and providers in the first place. Moreover, by providing assurance that risk mitigation requirements are met, the SOW application 136 may allow the organization to be less conservative and restrained during the negotiation process, thus further increasing the ability of the organization to reach master agreements and agreements as to particular SOWs. The organization may thus devote more of its resources to negotiating with an increased number of customers, negotiating with larger customers, etc.

Still further, by populating the first portion 402 of the selected SOW template with customer-specific terms and conditions and/or customer-specific project-specific terms and conditions that the organization and the customer have previously agreed (e.g., in a master agreement) are to be included in every SOW between the organization and the customer, the SOW application 136 avoids the need for a user to access a database or other repository of SOW terms and conditions, identify the terms and conditions that should always be included in the customer's SOWs and/or that should always be included in the customer's SOWs that pertain to a particular type of project, and insert the identified terms and conditions into each of the customer's SOWs as appropriate. Population of standardized terms and conditions also avoids user errors in identifying and inserting such terms and conditions into the customer's SOWs from a repository.

Continuing as to the method 200, the SOW application 136 may insert one or more customer contract distinctions into the selected template for a SOW between the organization and the customer, as requested or required by the customer or by the organization (block 220). For example, a customer contract distinction may be a requirement on the part of a customer that certain individuals employed by the organization or by a provider (e.g., a subcontractor that is to provide goods and/or services with respect to a SOW between the organization and the customer) have attained a particular certification or passed a background check. The databases 106a-106n may store indications of such customer contract distinctions. Additionally or alternatively, in some embodiments, the databases 106a-106n may store indications of provider contract distinctions that may need to be inserted into a SOW as requested or required by a particular provider or by the organization. For example, a provider contract distinction may be a requirement on the part of a provider that a customer agree (e.g., in a SOW between the customer and the organization) to particular terms and conditions establishing that services will be performed on the premises of the customer at particular times, and/or according to particular intervals of time, etc. Content corresponding to this requirement may be “flowed”—as further discussed below—into the corresponding SOW between the customer and the organization in a manner that augments or, in some examples, contradicts the customer-specific terms and conditions set forth in the corresponding SOW between the customer and the organization.

In any event, the function described by the block 220 may insert one or more customer (or provider) contract distinctions into the selected SOW template according to suitable criteria. For example, the SOW application 136 may present a listing or other suitable summary of the particular contract distinctions stored in the databases 106a-106n that may be used for the customer (or provider) for which the SOW is to be created. Each contract distinction stored in the databases 106a-106n may be stored along with suitable information that associates that contract distinction with one or more particular customers (or providers). Based on the received indication of the customer (or provider) for which the SOW is to be created (block 212), the SOW application 136 may determine the contract distinctions to be presented in a listing for possible insertion into the selected SOW template. The user of the organization workstation 101 may then select one or more of the listed contract distinctions for insertion into the selected SOW template.

In some embodiments, the function described by the block 220 may also or alternatively populate the selected SOW template with one or more contract distinctions without first presenting the one or more contract distinctions to the user for selection. For example, a customer (or provider) contract distinction may be stored in the databases 106a-106n along with suitable information indicating that the contract distinction is to be populated within any selected SOW template used to create a SOW to which a particular customer (or provider) is to be a party. In such embodiments, the function described by the block 220 may be performed by the function described by the block 216—in other words, populating the selected SOW template with customer-specific (or provider-specific) terms and conditions (block 216) may, in such cases, necessarily include populating the selected SOW template with terms and/or conditions that constitute a customer contract distinction.

In still other examples, a customer contract distinction may be stored in the databases 106a-106n along with suitable information indicating that the customer contract distinction is to be populated within any selected SOW template used to create a SOW to which a particular customer is to be a party and with respect to which a particular provider, one of a particular group or class of providers, etc. is to provide goods and/or services. For example, such a customer contract distinction may be a requirement on the part of a customer that certain individuals employed by any provider within a certain group or class of providers have passed a background check. Thus, a customer contract distinction may be populated without the need for selection by a user, but may be populated in a manner different from the population of a selected SOW template with information that is standardized for a customer.

In any event, after populating the first portion 402 of the selected SOW template with information standardized for the customer (block 216), and, in some cases, after populating the selected SOW template with one or more customer contract distinctions (block 220), the SOW application 136 may cause certain information (content) from the selected SOW template to flow into a template for a corresponding SOW between the organization and a provider (also referred to herein as a “provider-facing SOW”) (block 224). The SOW application 136 may additionally or alternatively cause certain information from such a provider-facing SOW to flow into the selected SOW template (block 224). A corresponding provider-facing SOW may be, for example, a SOW between the organization and a provider (e.g., subcontractor) that is to be engaged by the organization to provide goods and/or services with respect to the SOW between the organization and the customer (also referred to herein as a “customer-facing SOW”).

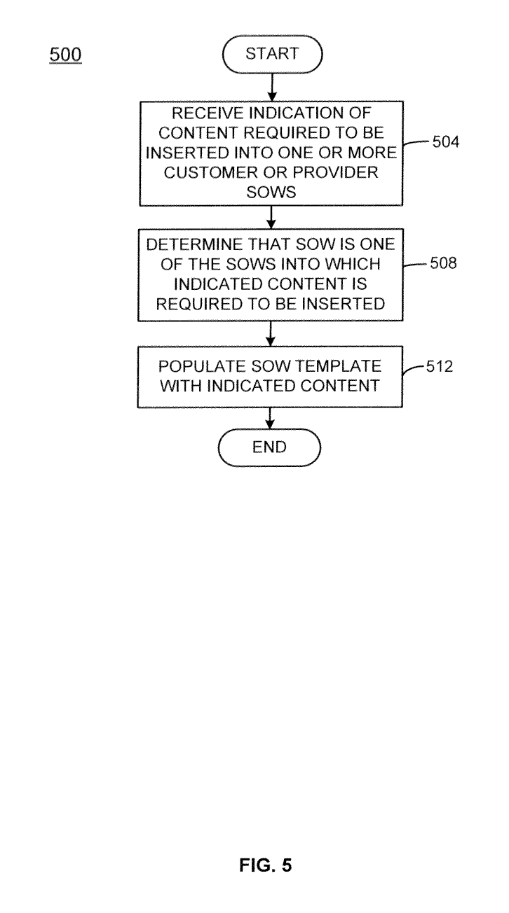

For example, if the provider that is to be engaged with respect to the customer-facing SOW requires that certain information be included in any customer-facing SOW with respect to which the provider is engaged, the function described by the block 224 may flow such information into the template for the customer-facing SOW. Thus, the function described by the block 224 may include determining the identity of a provider that is to be engaged by the organization with respect to the customer-facing SOW. Depending upon the information to be flowed and the provider's preferences, the information may be flowed into either the first portion 402 of the customer-facing SOW template, the second portion 404 of the customer-facing SOW template, or, in some cases, parts of the information may be flowed into the first portion 402 and parts of the information may be flowed into the second portion 404. An example implementation of the function described by the block 224 is described in greater detail with respect to FIG. 5. In some cases, the organization may not engage a provider (e.g., subcontractor) with respect to a customer-facing SOW, and the function described by the block 224 may be eliminated. The function described by the block 224 may likewise be eliminated where the organization engages (or is to engage) a provider with respect to a customer-facing SOW but the provider does not require any information to be included in customer-facing SOWs with respect to which the provider is engaged.

Conversely, in the situation where the selected SOW template is a template for a provider-facing SOW, the function described by the block 224 may cause certain information from the selected SOW template to flow into the corresponding customer-facing SOW, and/or the function described by the block 224 may cause certain information from the corresponding customer-facing SOW to flow into the selected SOW template. For example, if the customer that is (or that is to be) a party to the corresponding customer-facing SOW requires that certain information be included in any SOW between the organization and a provider that pertains to the provision of goods and/or services to the customer, the function described by the block 224 may cause such information to flow into the provider-facing SOW. In such a situation, the function described by the block 224 may include determining the identity of a customer for whose benefit the provider is ultimately to provide the goods and/or services detailed in the provider-facing SOW.

In some cases, information that is flowed from a customer-facing SOW into a provider-facing SOW or vice-versa may correspond to a customer (or provider) contract distinction. The customer or provider contract distinction may be inserted into a respective customer-facing SOW or provider-facing SOW as described above. Moreover, in some cases, information that is flowed from a customer-facing SOW into a provider-facing SOW or vice-versa may not be information that is indicated by a customer or provider as being required for insertion into any corresponding provider-facing SOW or customer-facing SOW. For example, a customer may only require a contract distinction to be inserted into certain ones of its SOWs, and may likewise only require that information corresponding to the contract distinction be flowed into certain corresponding provider-facing SOWs.

Further, in some cases, information flowed into a provider-facing or customer-facing SOW may not correspond to a customer contract distinction or provider contract distinction. For example, a user of the organization workstation 101 may input information into a customer-facing SOW or provider-facing SOW and specify that such information is to be flowed to a corresponding provider-facing SOW or customer-facing SOW. Such information may be flowed to a corresponding provider-facing SOW or customer-facing SOW for any desired reason, e.g., simply because the organization sees a benefit in flowing such information. Such information may be, for example, information that is not included in a customer or provider contract distinction but that a customer or provider nevertheless requests to be added to a customer-facing SOW or provider-facing SOW and flowed into a corresponding provider-facing SOW or customer-facing SOW. In another example, a customer or provider may request such information to be flowed into a template for a corresponding provider-facing SOW or customer-facing SOW without requiring that such information be inserted in the customer's or provider's own SOW. In either case, it is noted that because such information is requested to flow into a particular corresponding provider-facing SOW or customer-facing SOW, such information also is not required for insertion into any provider-facing SOW or customer-facing SOW with respect to which a customer or provider contracts with the organization.

In any event, the customer or provider may request information to be flowed into a template for a corresponding provider-facing SOW or customer-facing SOW via a suitable input to the customer workstation 102 or the provider workstation 103, as the case may be. The SOW application 136 may require proper authentication by a user of the customer workstation 102 or the provider workstation 103, and may use authentication information provided by such a user to manage the ability of the user to require or request that certain information be flowed into a corresponding provider-facing SOW or customer-facing SOW. Each of the customer workstation 102 and the provider workstation 103 may be used to access the SOW application 136 by accessing a corresponding web-based portal via the network 108, in some embodiments. In some cases, the servers 104a-104n may provide customized web-based portals for each customer and each provider. These customized web-based portals may be simplified versions of the web-based portal accessed by a user of the organization workstation 101, as discussed above. Moreover, a user of the organization workstation 101 may access a library of various pieces of content that providers may request to be flowed to customer-facing SOWs (also referred to as “provider flow-ups”) by selecting the provider flow-ups option 316 as shown in FIG. 3, in some embodiments. Similarly, a user of the organization workstation 101 may access a library of various pieces of content that customers may request to be flowed to provider-facing SOWs (also referred to as “customer flow-downs”) by selecting the customer flow-downs option 320, in some embodiments.

Further, in the situation where a customer or provider requests that information be flowed into a corresponding provider-facing SOW or customer-facing SOW and that corresponding information be inserted into the customer's or provider's own SOW, the SOW application 136 may allow different levels of permission with respect to the customer's or provider's ability to influence its own SOW and that of the corresponding provider or customer. For example, a customer may be able to cause certain information to be inserted, at least tentatively, into its own SOW without the need for any approval, but the SOW application 136 may require approval by a user of the organization workstation 101 before flowing corresponding information into the template for the corresponding provider-facing or customer-facing SOW.

Continuing as to the method 200, the SOW application 136 may receive, from a user (e.g., a user of the workstation 101), an indication or indications of additional content to be included in the SOW being created and/or managed (block 228). The additional SOW content may be stored in the databases 106a-106n and may include content that is not standardized for the customer (or provider) but is nonetheless available for use in SOWs to which the customer (or provider) is a party. The additional SOW content may include SOW content associated with a plurality of SOW categories. For example, the additional SOW content may include one or more of a project description (e.g., a description of scope of services, project scheduling, location(s) at which services are to be performed, etc.), SOW contributor information, contact information for the customer (or provider), contact information for the organization, professional services fees information, etc., as further described below. In some embodiments, some of the aforementioned information may be pre-entered in the selected SOW template by default, and the function described by the block 228 may receive an indication or indications from the user as to whether such pre-entered information is to be changed.

In some embodiments, the additional SOW content may also or alternatively include content that is input directly by the user and is not stored in the databases 106a-106n. For example, the user may select (e.g., via the user input/output interface 122) certain stored SOW content that is to be used in a description of the scope of services that are to be provided with respect to a SOW, and may also select an option to input further content that is to be used in the description of the scope of services in addition to the stored SOW content that the user selected. Thus, in this example, the function described by the block 228 may receive an indication of the stored SOW content that the user selected, and may also receive an indication of the further content in the form of the user's inputs. For example, the user may specify the further content to be used in the description of the scope of services by using the user input/output interface 122 to type such content into a text box displayed on the display device 120, and the function described by the block 228 may thereafter receive the text typed into the text box.

Likewise, the user may also or alternatively select certain stored SOW content that includes one or more of project scheduling language, location(s) at which services are to be performed, etc. The user may additionally or alternatively select an option to input project scheduling language and/or location information that is not stored in the databases 106a-106n. Moreover, in some embodiments, the function described by the block 228 may cause the display device 120 to present the user with one or more default options for additional SOW content. For example, the databases 106a-106n may store indications of default scope of services information for different customers (or providers), default project scheduling language, default locations, etc. The user may then select the default option or may select a different suitable option(s) in order to include other stored SOW content from the databases 106a-106n and/or in order to directly input content to be included in the SOW.

With continued reference to the function described by the block 228, the SOW application 136 may also receive an indication or indications of content such as, for example, SOW contributor information and/or contact information for the customer (or provider), contact information for the organization, etc. In some embodiments, the function described by the block 228 may cause the display device 120 to present the user with one or more default options for such content. As described above, such default options may be stored in the databases 106a-106n as being associated with different customers (or providers), and upon receiving an indication of the customer (or provider) for which the SOW is to be created (block 212), the SOW application 136 may present the appropriate default option(s) to the user. In other examples, the user may simply choose to include appropriate stored content from the databases 106a-106n and/or may directly input appropriate content.

As just one further example, and as mentioned above, the function described by the block 228 may also or alternatively receive an indication(s) of professional services fees information to be included in the SOW being created and/or managed. Professional services fees information may include, for example, descriptions of individual fees, information regarding travel and expenses to be incurred by the organization or provider (and, in some cases, later passed on to the customer or organization), additional payment details, etc. According to various embodiments, the indication(s) of professional services fees information may be received in any suitable manner, including in the manners described above with respect to other types of information. Moreover, it is noted that the types of information described herein are by way of example only. The function described by the block 228 may receive indications of any suitable additional or alternative types of information that are to be included in the SOW.

After receiving the indication or indications of additional content to be included in the SOW (block 228), the SOW application 136 may populate the selected SOW template with the indicated additional content (block 232). As discussed above, and with reference to the example SOW template 400, such additional content may be populated within the second portion 404, which may be, for example, an upper portion of the SOW template 400. Accordingly, additional content within the SOW that is not standardized for the customer or provider may be arranged and presented according to the beneficial SOW template structure described above, thus allowing more efficient review and approval of SOWs, more efficient negotiation of SOW terms and conditions, etc.

While the method 200 may generally group standardized information (content) within the first portion 402 and non-standardized information within the second portion 404, in some cases, the first portion 402 may include non-standardized information. For example, information flowed from a provider-facing SOW template into a customer-facing SOW template (or vice versa) may be flowed into the first portion 402 but may not be standardized for the customer (or provider). More specifically, such information may, for example, contradict customer-specific (or provider-specific) terms and conditions included in the first portion 402.

With reference now to a block 236, the method 200 may subsequently include generating the desired SOW from the SOW template that has been selected (block 208) and populated (e.g., blocks 216, 220, 224, and 232). For example, if desired, the SOW application 136 may send the populated SOW template to the customer (or provider) for review and approval. For example, the customer workstation 102 may be operated by or otherwise accessible to a particular customer, and the SOW application 136 may send (e.g., upon an appropriate selection by the user of the organization workstation 101) the populated template for the SOW between the particular customer and the organization to the customer workstation 102 via the link 127a, the network 108, and the link 128. Where the example method 200 is used to create and/or manage a provider-facing SOW, the SOW application 136 may send (e.g., upon an appropriate selection by the user of the organization workstation 101) the populated template for the provider-facing SOW to the provider workstation 103 via the link 127a, the network 108, and the link 129, where the provider workstation 103 is operated by or otherwise accessible to the particular provider that is (or that is to be) a party to the provider-facing SOW.

In some embodiments, the function described by the block 236 may use the populated SOW template to generate a Portable Document Format (PDF) version of the SOW, and/or a version of the SOW that is compatible with word processing software used by the organization and/or customer, etc. In some embodiments, the method 200 or portions thereof may be repeated as needed or desired in order to modify the SOW and/or create additional versions of the SOW. Thus, the function described by the block 236 may also generate a further version of the SOW where the function described by the block 236 has already generated one or more prior versions of the SOW, for example.

Furthermore, in some embodiments, the function described by the block 236 may generate the text of the SOW in two different colors, where textual information standardized for the customer or provider that is a party to the SOW is presented in one color, and non-standardized textual information is presented in another color. Additionally or alternatively, in some embodiments, the function described by the block 236 may identify any modifications to the customer-specific (or provider-specific) terms and conditions of the SOW by underlining and/or bolding such modifications, or in any other suitable manner. For example, such modifications may occur when information flowed from a corresponding provider-facing (or customer-facing) SOW contradicts information included in the customer-specific (or provider-specific) terms and conditions.

Of course, the method 200 is but one example of a method that may be implemented using the system 100 (or another suitable system). It will be appreciated that the system 100 may also or alternatively be used to implement different methods. For example, the system 100 may be used, generally speaking, to edit various features provided by the SOW application 136, and/or to edit various features of the SOW content stored in the databases 106a-106n and used by the SOW application 136. More particularly, the system 100 may be used to create and edit SOW templates, including primary templates and sub-templates. In some embodiments, the organization may designate different classes or permission levels of users of the SOW application 136. For example, such classes of users may include SOW creators, SOW editors, SOW template creators, and SOW template editors. Whereas, for example, SOW creators may have permission to create and edit individual SOWs in the manner described above, other tasks such as the creation and editing of SOW templates may be restricted to, for example, SOW editors. Thus, generally speaking, the SOW application 136 may provide differing levels of or types of access to different users based on, for example, user authentication information provided by each user via the organization workstation 101 and a web-based portal. For example, the SOW application 136 may provide a SOW editor with an option to specify the SOW category or categories with which a newly created or edited SOW template is to be associated, and may also allow the SOW editor to specify default content (if any) that is to be pre-entered in the SOW template.

As another example, the system 100 may be used to create and edit SOW categories and/or the associations of SOW templates with SOW categories. More particularly, the SOW application 136 may permit a SOW editor to create SOW categories that correspond to any of the one or more groups to which the SOW editor belongs, and/or may permit the SOW editor to associate existing SOW templates with categories corresponding to the group(s) to which the SOW editor belongs.

As yet another example, the system 100 may be used to create (and/or edit) customer-specific terms and conditions and/or customer-specific project-specific terms and conditions. More particularly, the SOW application 136 may permit certain users to input terms and conditions that are to be created and then select a customer (or, if desired, multiple customers) with which such terms and conditions are to be associated. The terms and conditions may then be stored in the databases 106a-106n as being associated with (i.e., specific to) the one or more selected customers. Similarly, the SOW application 136 may permit certain users to edit existing terms and conditions and/or to edit existing associations of terms and conditions with customers. The SOW application 136 may also allow similar actions with respect to customer-specific project-specific terms and conditions, provider-specific terms and conditions, and provider-specific project-specific terms and conditions. If desired, the SOW application 136 may implement or invoke an electronic document processing application that may be used to edit electronic documents containing such terms and conditions with minimal user interaction required. An example of such an electronic document processing application is disclosed in U.S. patent application Ser. No. 13/441,131, entitled “SYSTEM AND METHOD FOR PROCESSING ELECTRONIC DOCUMENTS,” filed on Apr. 6, 2012, the entire disclosure of which is hereby incorporated by reference herein for all purposes.

In some embodiments, the SOW application 136 may provide for a further permission level higher than that of both a SOW creator and a SOW editor. Users of the organization workstation(s) 101 having the third permission level may be tasked with, for example, creating and editing customer-specific and provider-specific terms and conditions, customer-specific and provider-specific project-specific terms and conditions, etc. Furthermore, in some embodiments, any requested change to content (e.g., customer-specific) terms and conditions made by a user having an insufficient level of permission to make the change on his or her own may be sent to a user having the appropriate level of permission. In some embodiments, such a request may be sent to the appropriate user in the form of an automated e-mail, instant message, etc. generated by the SOW application 136. For example, a user having the appropriate level of permission may be using a different one of multiple organization workstations 101 and may receive the request via the different organization workstation 101.

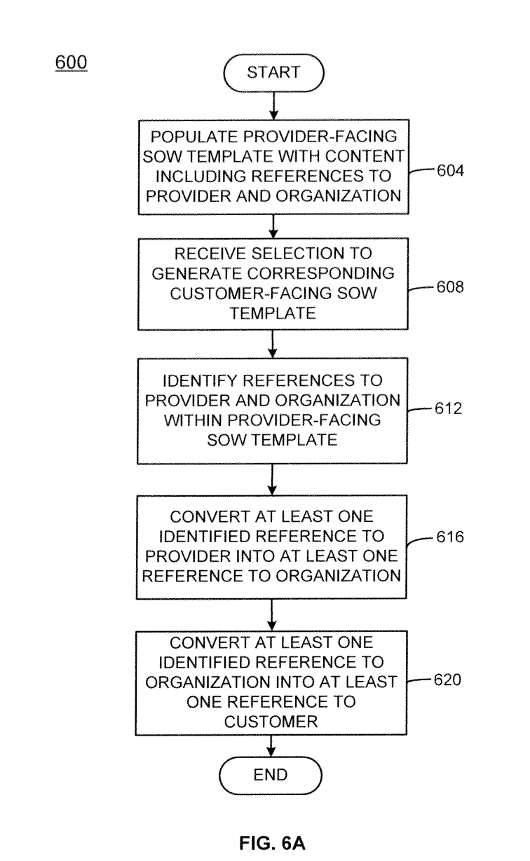

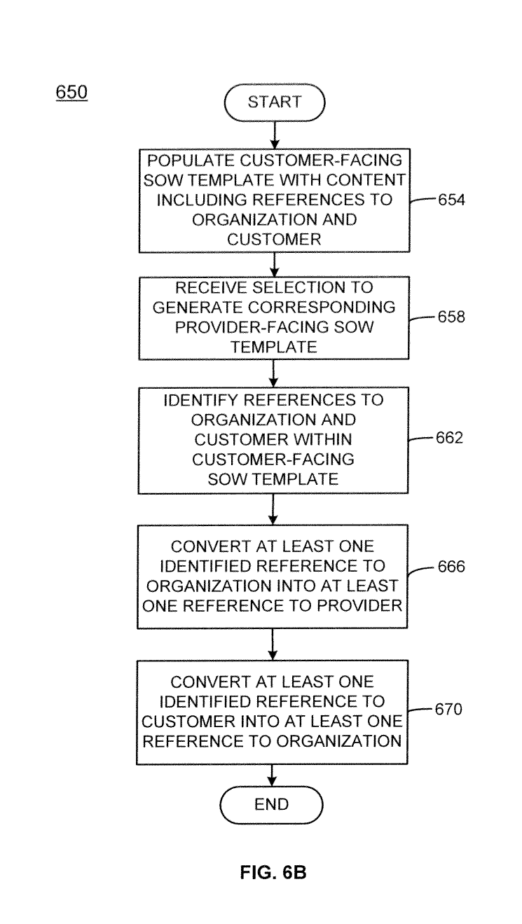

Still further example methods are described with respect to FIGS. 5 and 6. In particular, FIG. 5 is a flow chart of an example method 500 for flowing content into a SOW template, such as a SOW template utilized in conjunction with the SOW application 136, according to various embodiments. Thus, it will be understood that in at least some embodiments, FIG. 5 represents one or more portions or routines of one or more computer programs used in implementing the SOW application 136. More particularly, with reference to the method 200, the method 500 or portions thereof may be used to implement the function described by the block 224, in some embodiments. Accordingly, for ease of explanation, the method 500 will be described with reference to the system 100 of FIG. 1 and the method 200 of FIG. 2. However, it will be understood that the method 500 may be implemented by a system other than the system 100, and that the method 500 need not be implemented in conjunction with the method 200.

The method 500 may include receiving an indication, via the provider workstation 103 (or customer workstation 102), of content that a particular provider (or customer) requires to be inserted into one or more customer-facing (or provider-facing) SOWs with respect to which the particular provider (or customer) has entered (or is to enter) into a corresponding SOW with the organization (block 504). More particularly, it will be understood that the method 500 may be used to cause content to flow into a SOW template for a SOW between the organization and a customer, and/or to cause content to flow into a SOW template for a SOW between the organization and a provider (e.g., subcontractor). In cases where the method 500 is used to cause content to flow into a SOW template for a SOW between the organization and one of its customers, the function described by the block 504 may receive an indication from a provider of content that the provider requires to be inserted into one or more customer-facing SOWs with respect to which the provider is to provide goods and/or services pursuant to the terms of a corresponding provider-facing SOW between the organization and the provider.

For example, such content may include particular terms and conditions establishing that services will be performed on the premises of the customer at particular intervals of time, which particular intervals may reflect the availability of the provider to provide the stated services. As another example, such content may establish certain rights or obligations between the provider and the customer, such as intellectual property ownership rights. As another example, such content may include non-solicitation language that may protect a provider's employees from being hired by the customer. As a further example, such content may include provisions requiring that the customer disclose hazardous conditions and possibly indemnify the provider from damage caused by such hazardous conditions or from damage cause by non-disclosed hazardous conditions. As another example, such content may include provisions requiring that the customer not disclose any Personally Identifiable Health Information (PHI) or other personal information for which the provider wishes to not be responsible. As a final example, such content may include provisions requiring that the customer obtain all necessary licenses to third party intellectual property provided to the provider during the provision of services.

As discussed above with respect to the function performed by the block 224, such content may correspond to a provider contract distinction that is inserted into a corresponding provider-facing SOW as required by the provider, and an indication that such content is to be inserted into the customer-facing SOW may be received by the function described by the block 504. The function described by the block 504 may, but need not, receive such an indication in response to a suitable input or selection by a user of the provider workstation 103.

By requiring the insertion of such content into customer-facing SOWs with respect to which the provider is to provide goods and/or services, the provider may have greater assurance that disputes between the organization and the customer will be avoided or certain rights of the provider will be assured, thus lessening the provider's exposure to liabilities or its exposure to risk from lack of clarity with respect to certain rights or obligations between the provider and customer, such as intellectual property ownership rights. Of course, the foregoing example is merely for purposes of illustration, and a provider may require that any suitable content be inserted into a customer-facing SOW. Moreover, as discussed above with respect to the function described by the block 224, the provider may require that certain content be inserted into any customer-facing SOW with respect to which the provider is to be engaged. Additionally or alternatively, the provider may require that certain content be inserted only into one or more particularly identifiable customer-facing SOWs with respect to which the provider is to be engaged, such as a certain category of customer-facing SOWs.

In another example, the content required for insertion into one or more corresponding customer-facing SOWs need not correspond to a provider contract distinction. In yet another example, the content required for insertion into one or more corresponding customer-facing SOWs may correspond to content included within a provider's provider-specific terms and conditions or within a provider's provider-specific project-specific terms and conditions. In still another example, the content required for insertion into a corresponding customer-facing SOW may include content within a proposed modification by the provider to a particular provider-facing SOW, where the proposed modification will affect the corresponding customer-facing SOW. Thus, in addition to allowing the provider to identify content that is required for insertion into customer-facing SOWs as a general matter, the method 500 may also allow the provider to make more specific changes to a particular provider-facing SOW during negotiations, which may allow the provider to account for unique circumstances involving the customer that is to be a party to the particular corresponding customer-facing SOW.

In other examples, the method 500 may be used to flow content into a SOW template for a SOW between the organization and a providers. In such examples, the function described by the block 504 may receive an indication from one of its customers that certain content is required to be inserted into one or more provider-facing SOWs pertaining to goods and/or services to be provided to the organization in furtherance of the organization's contractual obligations pursuant to a corresponding customer-facing SOW. For example, and with reference to the foregoing discussion of the function described by the block 224, such content may include particular terms and conditions requiring that certain individuals employed by a provider and involved in particular activities with respect to the customer's SOW(s) have attained a particular certification, passed a background check, etc. By requiring the insertion of such content into a provider-facing SOW, the customer may have greater assurances of the qualifications, integrity, etc. of individuals who will provide services for the customer but who are employed by an entity (i.e., a provider) with which the customer does not have a direct contractual relationship. As with content required for insertion into a customer-facing SOW, it will be understood that the foregoing example of content required for insertion into a provider-facing SOW is merely for purposes of illustration, and that a customer may require that any suitable content be inserted into a provider-facing SOW. Moreover, the customer may require that certain content be inserted into any corresponding provider-facing SOW. Additionally or alternatively, the customer may require that certain content be inserted only into one or more particularly identifiable corresponding provider-facing SOWs, such as a certain category of provider-facing SOWs.

In any event, the function described by the block 504 may receive the indication of content required for insertion into provider-facing SOWs in any suitable manner, such as, for example, in response to a suitable input or selection by a user of the customer workstation 102. More generally, it is noted that the remaining examples herein with respect to the method 500 will refer to the flowing of content into customer-facing SOWs, it being understood that the various described features may be applied, as appropriate, to the flowing of content into provider-facing SOWs.

After receiving an indication (or indications) from a provider (or customer) of content that is required for insertion into one or more customer-facing (or provider-facing) SOWs, the method 500 may include determining that a particular customer-facing (or provider-facing) SOW being created using a template provided by the SOW application 136 is one of the one or more SOWs into which the content indicated by the provider (or customer) is to be inserted (block 508). In some cases, the function described by the block 504 may simply receive a proposed modification to a particular customer-facing SOW template from a provider (or vice versa), and the function described by the block 508 may thus effectively determine that the particular customer-facing SOW template corresponds to (i.e., is the template for) the one SOW into which the proposed modification is to be inserted. As further described below, the method 500 may then include populating the proposed modification within the particular customer-facing SOW template.

In another example, the function described by the block 504 may receive an indication that content corresponding to a provider contract distinction is to be inserted into any template for a customer-facing SOW with respect to which a particular provider is to be engaged (or vice versa), and the function described by the block 508 may thus effectively determine that any customer-facing SOW template being populated using the SOW application 136 and with respect to which the particular provider is to be engaged corresponds to (i.e., is the template for) one of the one or more SOWs into which the content corresponding to the provider contract distinction is to be inserted. In still other examples, the function described by the block 504 may receive an indication from a provider that content is to be inserted into any templates for customer-facing SOWs meeting certain criteria (or vice versa), and the function described by the block 508 may thus determine whether a particular customer-facing SOW template being populated using the SOW application 136 meets the certain criteria. For example, if a provider requires certain provisions regarding time intervals at which services will be rendered to be inserted into a template for a corresponding customer-facing SOW based on whether the associated customer is one of a specified group of customers, the function described by the block 508 may make the described determination by determining whether the customer that is to be a party to the corresponding customer-facing SOW is one of the specified group of customers. As another example, the provider may wish to insert certain IP licensing restrictions for a certain class of customers, for example, customers in a similar field as the provider. In this case the function described by block 508 may make the described determination by determining whether the customer that is to be a party to the corresponding customer-facing SOW is one of the specified group of customers. As a final example, the provider may wish to place restrictions on its receipt of certain types of risky information such as Personally Identifiable Health Information (PHI). In this case the function described by block 508 may make the described determination by determining whether the customer that is to be a party to the corresponding customer-facing SOW is one for which the restriction should be imposed.

A function described by a block 512 may then populate the SOW template with the content that has been indicated by the particular provider (or customer) (e.g., block 504) based on determining (block 508) that the SOW being created (or managed) using the SOW template is one of the one or more SOWs into which the indicated content is required for insertion. For example, at least one of the servers 104a-104n may retrieve the indicated content from at least one of the databases 106a-106n so that the function described by the block 512 may populate the SOW template with the indicated content.

FIGS. 6A and 6B are flow charts of example methods 600 and 650 for “flipping” a provider-facing SOW template in order to generate (e.g., populate) a corresponding customer-facing SOW template (FIG. 6A) and for “flipping” a customer-facing SOW template in order to generate (e.g., populate) a corresponding provider-facing SOW template (FIG. 6B), according to various embodiments. As described further below, the method 600 may be used to “flip” a populated provider-facing SOW template by performing certain operations that essentially modify the content populated within the provider-facing SOW template into content suitable for populating within the corresponding customer-facing SOW template. Similarly, the method 650 may be used to “flip” a populated customer-facing SOW template by performing certain operations that essentially modify the content populated within the customer-facing SOW template into content suitable for populating with the corresponding provider-facing SOW template.

The provider-facing and customer-facing SOW templates may be SOW templates utilized in conjunction with the SOW application 136. Thus, it will be understood that in at least some embodiments, FIGS. 6A and 6B represent one or more portions or routines of one or more computer programs used in implementing the SOW application 136. For ease of explanation, the methods 600 and 650 will be described with reference to the system 100 of FIG. 1, and at times may be described with reference to one or more of the methods 200 or 500. However, it will be understood that the methods 600 and 650 may be implemented by a system other than the system 100, and that the methods 600 and 650 need not be implemented in conjunction with either of the methods 200 or 500. Moreover, while the methods 600 and 650 are generally discussed together herein, it will be understood that the methods 600 and 650 need not be implemented together. Instead, each of the methods 600 and 650 may be separately implemented as needed or desired.

The method 600 may include populating a provider-facing SOW template with content from one or more databases (e.g., one or more of the databases 106a-106n) that includes one or more references to the provider that is to be a party to the SOW created using the provider-facing SOW template and one or more references to the organization (block 604). In some embodiments, one or more of the references to the provider and/or one or more of the references to the organization may be included within one or more provider contract distinctions that the provider has required to be inserted into the provider-facing SOW. As a more particular example, one or more of the references to the provider and/or one or more of the references to the organization may be included within terms and conditions establishing that the organization is to hire the provider to render certain services, and that those services are to be rendered at particular intervals of time.

Correspondingly, the method 650 may include populating a customer-facing SOW template with content from one or more databases (e.g., one or more of the databases 106a-106n) that includes one or more references to the organization and one or more references to the customer that is to be a party to the SOW created using the customer-facing SOW template (block 654). In some embodiments, one or more of the references to the organization and/or one or more of the references to the customer may be included within one or more customer contract distinctions that the customer has required to be inserted into the customer-facing SOW. As a more particular example, one or more of the references to the organization and/or one or more of the references to the customer may be included within terms and conditions establishing that certain individuals retained by the organization to render services to the customer must have passed a background check.

The method 600 may further include receiving a selection to generate a corresponding customer-facing SOW template (block 608). That is, the function described by the block 608 may receive a selection to generate a template for a SOW between the organization and a customer, where the provider is to provide goods and/or services with respect to the SOW between the organization and the customer. More particularly, the function described by the block 608 may receive a selection to generate the corresponding customer-facing SOW template from the provider-facing SOW template by “flipping” the provider-facing SOW template, as further described below.

Correspondingly, the method 650 may include receiving a selection to generate a corresponding provider-facing SOW template (block 658). That is, the function described by the block 658 may receive a selection to generate a template for a SOW between the organization and a provider, where the provider is to provide goods and/or services with respect to the SOW that is to be generated using the customer-facing SOW template. More particularly, the function described by the block 658 may receive a selection to generate the corresponding provider-facing SOW template from the customer-facing SOW template by “flipping” the customer-facing SOW template, as further described below.

With reference to the system 100, the selection to generate a corresponding customer-facing SOW template or provider-facing SOW template may be received (block 608 or 658) from a user of the organization workstation 101 by way of the user inputting a suitable command to the organization workstation 101 via the user input/output interface 122. The selection to generate the corresponding customer-facing SOW template or provider-facing SOW template may then be transmitted to the SOW application 136 via the I/O circuit 116, the network interface 124, the link 126, the network 108, and the link 127a, in some examples.

In response to receiving the selection to generate the corresponding customer-facing SOW template or provider-facing SOW template (block 608 or 658), the SOW application 136 may identify the references to the provider and the organization within the provider-facing SOW template, or may identify the references to the organization and the customer within the customer-facing SOW template, as the case may be (block 612 or 662). For example, one or more of the servers 104a-104n may parse the contents of the populated provider-facing SOW template and identify metadata indicative of the presence of a reference to the provider and/or the presence of a reference to the organization (block 612). Similarly, with reference to the method 650, one or more of the servers 104a-104n may parse the contents of the populated customer-facing SOW template and identify metadata indicative of the presence of a reference to the organization and/or the presence of a reference to the customer (block 662).

By way of example, such metadata may be or may include a particular symbol(s) (e.g., a bracket, parenthesis, highlighting, etc.) used to designate the presence of such a reference, which particular symbol(s) may or may not be visible to a user to whom the provider-facing or customer-facing template is displayed (e.g., via the organization workstation 101 or the provider workstation 103 or the customer workstation 102). In some cases, for example, the particular symbol(s) or other metadata may be present in a version of the provider-facing or customer-facing template as expressed using a suitable markup language(s), scripting language(s), and/or programming language(s), but may not appear in the displayed version of the provider-facing or customer-facing template that is generated using such language(s).

In any event, once the references to the provider and the organization are identified within the provider-facing template (block 612), the SOW application 136 may convert at least one of the identified references to the provider within the provider-facing template into at least one corresponding reference to the organization within the corresponding customer-facing template (block 616). Similarly, the SOW application 136 may convert at least one of the identified references to the organization within the provider-facing template into at least one corresponding reference to the customer within the corresponding customer-facing template (block 620). Depending upon the particular content that has been populated within the provider-facing SOW template (block 604), the conversion of identified references to the provider and/or the organization in this manner may yield SOW content that is suitable for use in the corresponding customer-facing SOW template.

For example, content populated within a provider-facing SOW template may include terms and conditions establishing that the organization is to hire the provider to render certain services at particular intervals of time, as further discussed above, and the provider may require that corresponding terms and conditions be flowed to the customer-facing SOW template. By developing the terms and conditions for the provider-facing SOW template in such a way that, except for converting references therein to the organization into references to the customer and converting references therein to the provider into references to the organization, essentially identical terms and conditions can be used in the corresponding customer-facing SOW, the method 600 may be used to allow rapid and easy generation of a customer-facing SOW template from a populated provider-facing SOW template. In some cases, terms and conditions including references to the provider and/or the organization may be or may include provider-specific terms and conditions and/or provider-specific project-specific terms and conditions.

In cases where the method 650 is used to “flip” a customer-facing SOW template in order to generate a corresponding provider-facing SOW template, the SOW application 136 may convert at least one of the identified references to the organization within the customer-facing SOW template into at least one corresponding reference to the provider within the corresponding provider-facing template (block 666). Similarly, the SOW application 136 may convert at least one of the identified references to the customer within the customer-facing SOW template into at least one corresponding reference to the organization within the corresponding provider-facing template (block 670). As with the method 600, the conversion of identified references in this manner may yield SOW content that is suitable for use in the corresponding provider-facing SOW template. That is, by developing content within the customer-facing template in such a way that, except for converting references therein to the organization into references to the provider and converting references therein to the customer into references to the organization, essentially identical content can be used in the corresponding provider-facing SOW, the method 650 may be used to allow rapid and easy generation of a provider-facing SOW template from a populated customer-facing SOW template.

It will be appreciated that the methods 600 and 650 also allow users to quickly view the effects of proposed insertions or changes to a provider-facing or customer-facing SOW template on the content of the corresponding customer-facing or provider-facing SOW template. Still further, the methods 600 and 650 facilitate more efficient cooperation between the organization, a customer, and a provider in, for example, the case where one such party proposes changes to its SOW (i.e., to the provider-facing SOW or the customer-facing SOW) and the approval of corresponding changes to the corresponding SOW (i.e., to the customer-facing SOW or the provider-facing SOW) by another such party is required. For example, if a provider proposes multiple rounds of changes to a provider-facing SOW via the provider workstation 103, each of which will affect the corresponding customer-facing SOW, the SOW application 136 may quickly and easily make the effects of each round of changes on the customer-facing SOW apparent by implementing the method 600 to “flip” the provider-facing SOW template and yield the changed template for the customer-facing SOW. The SOW application 136 may then send the template for the corresponding customer-facing SOW to the customer workstation 102 for display to the customer.

In order to facilitate the use of language in one SOW (i.e., provider-facing or customer-facing) that can be made suitable for use in the corresponding SOW (i.e., customer-facing or provider-facing) by the above-described conversions of references, the organization may provide appropriate sample language for the provider (or customer) to use in its SOW, such as by making a library of such language available to the provider (or customer) via a web portal accessed using the provider workstation 103 (or customer workstation 102). In another example, the organization may impose certain requirements on the provider (or customer) with regard to the drafting of such language, and/or may modify language proposed by the provider (or customer) to make that language suitable for use in the corresponding customer-facing (or provider-facing) SOW.

As another example, certain language pertaining to project description, project scheduling, payment of fees, etc. may be the same as between the provider and the organization and as between the organization and the customer except for the differences in the contracting parties that are agreeing to those terms and conditions in each instance. Consequently, the only changes to such terms and conditions that are necessary to create the customer-facing SOW template from the provider-facing SOW template may be the conversion of references to the provider and references to the organization, respectively, into references to the organization and references to the customer, respectively. Correspondingly, the only changes to such terms and conditions that are necessary to create the provider-facing SOW template from the customer-facing SOW template may be the conversion of references to the organization and references to the customer, respectively, into references to the provider and references to the organization, respectively. In some embodiments, such language or portions thereof may correspond to provider (or customer) contract distinctions, and/or to modifications proposed by the provider or customer during development of the SOW.

In some embodiments, the functions described by the blocks 616 and 620 may simply remove each of the identified references to the provider and replace these removed references with references to the organization (block 616), and remove each of the identified references to the organization and replace these removed references with references to the customer (block 620). In other embodiments, the functions described by the blocks 616 and 620 may change the meanings of references to the provider (block 616) and references to the organization (block 620) so that such references effectively become references to the organization and references to the customer, respectively, without changing the references themselves. For example, in cases where the references to the provider and/or the organization include words or phrases that are defined elsewhere within the provider-facing SOW template, the functions described by the blocks 616 and/or 620 may redefine such words or phrases so that the words or phrases formerly defined in a manner that caused them to refer to the provider are subsequently defined in a manner that causes them to refer to the organization (block 616), and/or so that the words or phrases formerly defined in a manner that caused them to refer to the organization are subsequently defined in a manner that causes them to refer to the customer (block 620). As a more particular example, the function described by the block 616 may redefine the term “provider” from the provider-facing SOW template so that this term indicates the organization when used in the corresponding customer-facing SOW template.

In some embodiments, the functions described by the blocks 666 and 670 may similarly remove each of the identified references to the organization and replace these removed references with references to the provider (block 666), and remove each of the identified references to the customer and replace these removed references with references to the organization (block 670). In other embodiments, the functions described by the blocks 666 and 670 may change the meanings of references to the organization (block 666) and references to the customer (block 670) so that such references effectively become references to the provider and references to the organization, respectively, without changing the references themselves. The functions described by the blocks 666 and 670 may change the meanings of references to the organization and references to the customer in a manner analogous to that discussed with respect to the functions described by the blocks 616 and 620.

In at least some embodiments, additional operations may be performed in order to “flip” a provider-facing SOW template in order to generate a corresponding customer-facing SOW template (or vice-versa). For example, content within the provider-facing SOW template that does not have corresponding content within the customer-facing SOW template (or vice versa) may be removed from the provider-facing SOW template (or customer-facing SOW template). As a more particular example, content that is standardized for the provider may be removed based on receiving the selection to generate the corresponding customer-facing SOW template (block 608), where such content standardized for the provider does not correspond to any content that is to be populated within the corresponding customer-facing SOW. Furthermore, in the above example, content that is standardized for the customer may be retrieved from one or more of the databases 106a-106n based on receiving the selection to generate the corresponding customer-facing SOW template (block 608), and such content may then be populated within the corresponding customer-facing SOW template, even though such content does not correspond directly to (e.g., is not a “flipped” version of) content within the provider-facing SOW template. Still further, with regard to the above example, it is noted that the content that is standardized for the provider and removed from the provider-facing SOW template may include one or more references to the provider, and may include one or more references to the organization. In other words, some references to the provider and/or the organization may be included within content that does not have corresponding content within the corresponding customer-facing SOW, and may thus be removed instead of being converted into references to the organization and/or the customer. With reference to the method 650, certain content within a customer-facing SOW may be removed in an analogous manner where that content does not have corresponding content within the corresponding provider-facing SOW.

One of ordinary skill in the art will recognize suitable variations of each of the example methods 200, 500, 600, and 650 in light of the teaching and disclosure herein. For example, in some embodiments, the function(s) described by one or more blocks or portions of blocks shown in one or more of FIG. 2, 5, 6A or 6B may not be performed, and/or one or more additional functions described by one or more additional blocks not shown in one or more of FIG. 2, 5, 6A or 6B may be performed. In other examples, the order shown in one or more of FIG. 2, 5, 6A or 6B does not indicate the order in which one or more of the methods 200, 500, 600, or 650 must be performed, and/or does not indicate that each function described by a block must be completed before another function described by another block begins.

Moreover, although the foregoing text sets forth a detailed description of numerous different embodiments, it should be understood that the scope of this patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and system described and illustrated herein without departing from the spirit and scope of the claims. Accordingly, it should be understood that the system and methods described herein are illustrative only and are not limiting upon the scope of the claims.

What is claimed is:

1. A method for use in generating a statement of work (SOW) between a first party and a second party, the method comprising:
receiving, with one or more computing devices each having a processor executing at least a portion of a SOW application and a memory coupled to the processor to store data associated with execution of the SOW application, a selection of an electronic template that is to be used to generate the SOW between the first party and the second party, wherein the first party to the SOW is an organization that provides at least one of goods or services to customers, and wherein the second party to the SOW is one of a plurality of customers of the organization or one of a plurality of providers to the organization;
receiving, with the one or more computing devices, an indication of the second party to the SOW;
retrieving, with the one or more computing devices, the selected electronic template from one or more databases that store a plurality of electronic templates including the selected electronic template and that store SOW content associated with a plurality of SOW categories;
retrieving from the one or more databases, with the one or more computing devices, based on the received indication of the second party, a portion of the stored SOW content that is standardized for the second party;
receiving, with the one or more computing devices, one or more indications from a user of additional content that is to be included in the SOW between the organization and the second party and that is not standardized for the second party;
populating, with the one or more computing devices, a first portion of the selected electronic template with content including at least some of the portion of the stored SOW content that is standardized for the second party; and
populating, with the one or more computing devices, a second portion of the selected electronic template that is distinct from the first portion of the selected electronic template with the additional content that is to be included in the SOW and that is not standardized for the second party.

2. The method of claim 1, further comprising presenting, with the one or more computing devices and to a user of the one or more computing devices, the populated first and second portions of the selected electronic template as distinct lower and upper portions of the selected electronic template.

3. The method of claim 1, further comprising generating, with the one or more computing devices, the SOW between the organization and the second party based on the selected electronic template such that the generated SOW includes the content populated within the first and second portions of the selected electronic template.

4. The method of claim 1, wherein the portion of the stored SOW content that is standardized for the second party comprises terms and conditions that the organization and the second party have agreed are to be included in every SOW between the organization and the second party.

5. The method of claim 4, further comprising receiving, with the one or more computing devices, an indication that at least some of the terms and conditions that the organization and the second party have agreed are to be included in every SOW between the organization and the second party are not to be included in the SOW to be generated using the selected electronic template;
wherein populating the first portion of the selected electronic template comprises populating, with the one or more computing devices, the first portion of the selected electronic template with the at least some of the portion of the stored SOW content that is standardized for the second party and without the at least some of the terms and conditions that are not to be included in the SOW.

6. The method of claim 1, further comprising:
identifying, with the one or more computing devices, references to the organization in the content populated within the first portion of the selected electronic template;
identifying, with the one or more computing devices, references to the second party in the content populated within the first portion of the selected electronic template;
converting, with the one or more computing devices, at least one of the identified references to the organization into at least one corresponding reference to the second party; and
converting, with the one or more computing devices, at least one of the identified references to the second party into at least one corresponding reference to the organization.

7. The method of claim 1, further comprising populating, with the one or more computing devices, the first portion of the selected electronic template with content that is not standardized for the second party, in addition to the at least some of the portion of the stored SOW content that is standardized for the second party.

8. The method of claim 1, further comprising populating, with the one or more computing devices, the selected electronic template with one or more contract distinctions required by the second party.

9. The method of claim 1, further comprising causing, with the one or more computing devices, content corresponding to content populated within the selected electronic template to flow into an electronic template that is to be used to generate a corresponding SOW between the organization and a third party.

10. A centralized statement of work (SOW) system for generating a SOW between a first party and a second party, the centralized SOW system comprising:
one or more databases storing a plurality of electronic templates and SOW content associated with a plurality of SOW categories;
one or more computing devices each having a processor and a memory coupled to the processor, the one or more computing devices communicatively coupled to the one or more databases, the one or more computing devices configured to:
receive a selection of an electronic template that is to be used to generate the SOW between the first party and the second party, wherein the first party to the SOW is an organization that provides at least one of goods or services to customers, and wherein the second party to the SOW is one of a plurality of a customers of the organization or one of a plurality of providers to the organization;
receive an indication of an identity of the second party to the SOW;
retrieve the selected electronic template from the one or more databases;
retrieve from the one or more databases, based on the indication of the identity of the second party received with the one or more computing devices, a portion of the stored SOW content that is standardized for the second party;
receive one or more indications from a user of additional content that is to be included in the SOW between the organization and the second party and that is not standardized for the second party;
populate a first portion of the selected electronic template with content including at least some of the portion of the stored SOW content that is standardized for the second party;
populate a second portion of the selected electronic template that is distinct from the first portion of the selected electronic template with the additional content that is to be included in the SOW and that is not standardized for the second party; and
generate the SOW between the organization and the second party based on the selected electronic template such that the generated SOW includes the content populated within the first and second portions of the selected electronic template.

11. The centralized SOW system of claim 10, wherein the one or more computing devices are configured to populate the first portion of the selected electronic template with content that is not standardized for the second party, in addition to the at least some of the portion of the stored SOW content that is standardized for the second party.

12. The centralized SOW system of claim 10, wherein the one or more computing devices are configured to populate the selected electronic template with content indicative of a requirement of the second party that a corresponding SOW between the organization and a third party include a particular agreement between the organization and the third party.

13. The centralized SOW system of claim 12, wherein the one or more computing devices are configured to populate the first portion of the selected electronic template with the content indicative of the requirement of the second party that the corresponding SOW between the organization and the third party include the particular agreement between the organization and the third party.

14. The centralized SOW system of claim 12, wherein the one or more computing devices are configured to populate the second portion of the selected electronic template with the content indicative of the requirement of the second party that the corresponding SOW between the organization and the third party include the particular agreement between the organization and the third party.

15. The centralized SOW system of claim 12, wherein the one or more computing devices are configured to cause content indicative of the particular agreement between the organization and the third party to flow into an electronic template that is to be used to generate the corresponding SOW between the organization and the third party.

16. The centralized SOW system of claim 10, wherein the first portion of the selected electronic template is a lower portion of the selected electronic template, and wherein the second portion of the selected electronic template is an upper portion of the selected electronic template.

17. The centralized SOW system of claim 10, wherein the portion of the stored SOW content that is standardized for the second party comprises one or more sets of project-specific terms and conditions, the organization and the second party having agreed that each of the one or more sets of project-specific terms and conditions is to be included in every SOW between the organization and the second party that pertains to a particular type of project, and wherein the at least some of the portion of the stored SOW content that is populated within the first portion of the selected electronic template comprises at least a portion of one of the sets of project-specific terms and conditions that corresponds to a particular type of project to which the SOW to be generated from the selected electronic template pertains.

18. The centralized SOW system of claim 10, wherein the additional content that is to be included in the SOW comprises a further portion of the stored SOW content that is associated with one or more of the plurality of SOW categories and that is not standardized for the second party.

19. The centralized SOW system of claim 10, wherein the additional content that is to be included in the SOW is not stored in the one or more databases, and wherein the one or more indications from the user of the additional content that is to be included in the SOW comprise one or more user inputs specifying the additional content that is to be included in the SOW.

20. A method for use in generating a statement of work (SOW) between a first party and a second party, the first party being an organization that provides at least one of goods or services to customers, the method comprising:
receiving, with one or more computing devices each having a processor executing at least a portion of a SOW application and a memory coupled to the processor to store data associated with execution of the SOW application, an indication of an electronic template corresponding to the SOW between the organization and the second party, wherein the second party is one of a plurality of customers of the organization or one of a plurality of providers to the organization;
receiving, with the one or more computing devices, a plurality of indications from a user of content to be included in the SOW between the organization and the second party;
dividing, with the one or more computing devices, a first portion of the indicated content that is standardized for the second party from a second portion of the indicated content that is not standardized for the second party so that the first portion of the indicated content is included within a first portion of the indicated electronic template and the second portion of the indicated content is included within a second portion of the indicated electronic template that is distinct from the first portion of the indicated electronic template, without receiving an indication from the user of which portion of the indicated content is the first portion that is standardized for the second party; and
generating, with the one or more computing devices, the SOW between the organization and the second party based on including the first portion of the indicated content within the first portion of the indicated electronic template and based on including the second portion of the indicated content within the second portion of the indicated electronic template.

21. The method of claim 20, wherein receiving the plurality of indications from the user of the content to be included in the SOW comprises:
receiving, with the one or more computing devices, an indication of the first portion of the content that is standardized for the second party by receiving an indication of an identity of the second party; and
receiving, with the one or more computing devices, an indication of the second portion of the content that is not standardized for the second party by receiving one or more user inputs specifying at least some of the second portion of the content.

22. The method of claim 21, wherein dividing the first portion of the indicated content that is standardized for the second party from the second portion of the indicated content that is not standardized for the second party comprises:
using the received indication of the identity of the second party to identify, with the one or more computing devices, the content that is standardized for the second party from among standardized content for a plurality of parties stored in one or more databases;
retrieving, with the one or more computing devices, the identified content that is standardized for the second party from the one or more databases;
populating, with the one or more computing devices, the first portion of the indicated electronic template with the retrieved content that is standardized for the second party; and
populating, with the one or more computing devices, the second portion of the indicated electronic template with the second portion of the content that is specified by the one or more user inputs and that is not standardized for the second party.

23. The method of claim 20, wherein dividing the first portion of the indicated content from the second portion of the indicated content without receiving an indication from the user of which portion of the indicated content is the first portion is performed based on the one or more computing devices identifying a stored association of the first portion of the indicated content with one of a plurality of parties.
